(19) United States
(12) Patent Application Publication
(10) Pub. No.: US 2016/0149794 A1
(43) Pub. Date: May 26, 2016

(54) AUTOMATIC NETWORK ROUTING ENGINE AGNOSTIC OF UNDERLYING INVENTORY OR NETWORK MANAGEMENT SYSTEM

(71) Applicant: DonRiver, Inc., Dallas, TX (US)

(72) Inventors: Richard John Coles, Sutton Coldfield (GB); Owain Robert Cole, Malmesbury (GB); Matthew Colton, Marietta, GA (US); Alvaro Osle-Dorremochea, Bath (GB)

(21) Appl. No.: 14/553,720

(22) Filed: Nov. 25, 2014

(51) Int. Cl. H04L 12/751; H04L 12/733; H04L 12/715

(52) U.S. Cl. CPC H04L 45/02; H04L 45/04; H04L 45/122

(57) ABSTRACT

A method of system for finding routes between network elements across a communication network, each network element having network equipment and connectivity data, the method including selecting at least one communication network for finding routes; reading input search parameters; providing a server having a routing graph database including connectivity data for each network element; synchronizing, by the routing graph database, the connectivity data with a corresponding discrete underlying inventory system; and identifying at least one route using the search parameters.

### FIELD OF THE INVENTION

The present invention relates to a network routing engine and, more specifically, to a network routing engine operating in a manner agnostic to any underlying inventory or network management systems, to facilitate finding routes across multi-technology and multi-domain telecommunication networks.

### BACKGROUND OF THE INVENTION

Communication Service Providers (CSP), e.g., network planners and network operators are typically designed to search for and to locate routes between network elements and, more specifically, along routes and between network elements that may each be provided by different suppliers. Conventionally, proprietary routing solutions are embedded into a particular manufacturer's existing inventory or network management system, which are designed to be used specifically for that inventory or network management system. This embedded solution provides necessary equipment and connectivity data; however, individual routing functionalities cannot be de-coupled or implemented in systems from other manufacturers. Thus, at the system level, routing across telecommunication networks and/or through various layers remains a vendor-specific process. For example, a proprietary inventory system that is configured to hold all of the information about the network, e.g., network elements and connectivity data, with which it may find routes across different networks. Consequently, if the required information is in a different system, conventional routing solutions, which work within the confines of a specific inventory/management system, necessitate different client software for different searches across different network domains. Indeed, in a scenario in which not all of the network information is present under a single inventory or network management system, the present art is incapable of finding routes across the various systems.

This solution becomes more problematic across multi-technology and/or multi-domain telecommunication networks comprising unique data models and connectivity data. The hierarchical nature of telecommunication networks suggests that, when searching for a route between sites or devices having a given capacity and a given technology, the route can only be provided easily if it spans at the same hierarchical level across the entire path.

Accordingly, it would be desirable to provide a system and method for providing a network routing function that is agnostic of the underlying network(s), network technologies, and/or network domains.

BRIEF SUMMARY OF THE INVENTION

A first aspect of the present invention includes a network routing engine for finding routes among a plurality of network elements, e.g., inventory or management systems, across a communication network, each network element having network equipment and connectivity data. In some embodiments, the routing engine includes an application server that is configured and arranged to perform route searches and to identify a route between at least two network elements. A routing graph database server includes a graph database of network equipment and connectivity data for each underlying, discrete system, and the routing graph database server is adapted to synchronize the connectivity data in the graph database with a corresponding underlying discrete system during route searches. In some implementations, the communication network is at least one of a multi-technology telecommunication network and a multi-domain telecommunication network. In some variations, the routing engine is executable on top of several different underlying systems, wherein the underlying systems include inventory systems, element managers, and/or network managers.

In some implementations, a first network element has connectivity data that differs from the connectivity data of a second network element. In some variations, the routing graph database server is adapted to combine connectivity data for different underlying systems to identify a route among multiple elements and across multiple systems.

A second aspect of the invention provides a method of finding routes across a communication network between network elements having network equipment and connectivity data. In some embodiments, the method includes selecting at least one communication network for finding routes, reading input search parameters, providing a server having a routing graph database including connectivity data for each network element, using the routing graph database to synchronize the connectivity data with a corresponding underlying, discrete inventory system, providing an application server, and identifying, by the application server, at least one route using the search parameters. In some implementations, the server-based routing graph database facilitates connectivity to each of the network elements, extraction of the network equipment and connectivity data from each network element, and population of the routing graph database with the network equipment and connectivity data. In some variations, populating the routing graph database includes distilling the network equipment and connectivity data to remove information not relevant to calculating a route.

In other implementations, identifying at least one route includes applying a business cost to the route. For example, the business cost may be selected from a minimum number of hops, a minimum distance between a source point and a destination point, a minimal cost for routes passing through lower hierarchy circuits, maximum free capacity along the route, a minimum number of fiber patches that need to be provided for a returned route, positive attribute costs for routes that go to particular devices in the returned route, negative attribute costs for routes that avoid particular devices in the returned route, diversity costs, or some combination thereof, which individual elements being weighted according to one or more routing rules.

Optionally, the method may also include combining connectivity data for different discrete, underlying inventory systems to identify a route or routes across multiple disparate, heterogeneous systems.

A third aspect of the present invention provides an article of manufacture having embedded computer-readable program portions encoded thereon for finding routes between network elements, e.g., inventory or management systems, across a communication network, each network element having network equipment and connectivity data in accordance with the methods and systems described above.

### BRIEF DESCRIPTION OF THE DRAWINGS

Further features, embodiments, and advantages of the present invention will become apparent from the following detailed description with reference to the drawings, wherein:

FIG. 1 shows an example of a multi-layer telecommunication network in accordance with the prior art;

FIG. 2 shows an illustrative embodiment of a system for defining a route between network elements or sites that is agnostic to the telecommunication network technology and the telecommunication network domain in accordance with the present invention;

FIGS. 3A and 3B show diagrammatic of distillation processes in accordance some embodiments of the present invention; and

FIG. 4 shows a flow diagram of an illustrative embodiment of a method of defining a route between network elements or sites that is agnostic to the telecommunication network technology and the telecommunication network domain in accordance with the present invention.

### DETAILED DESCRIPTION OF THE INVENTION

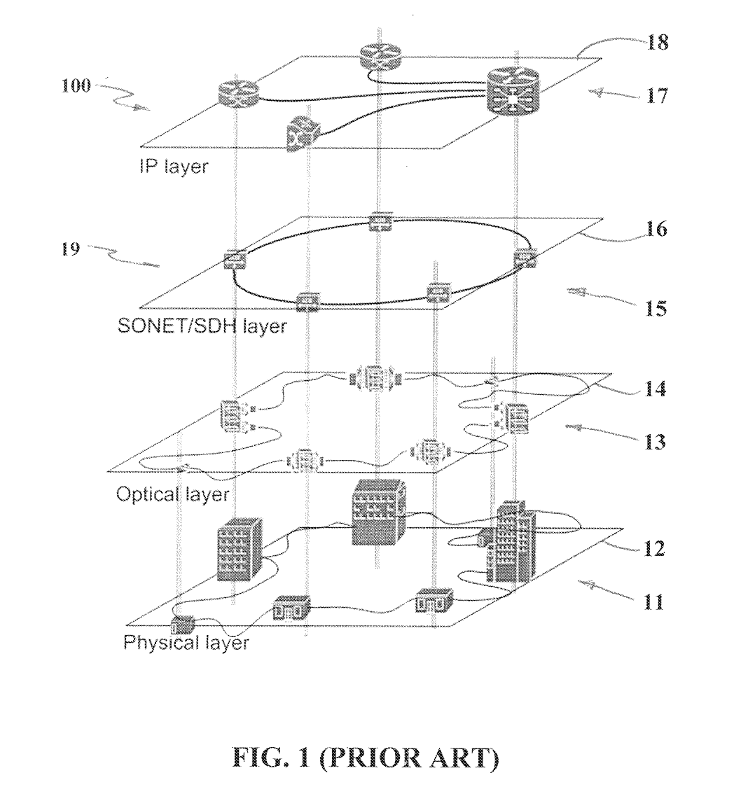

Referring to FIG. 1, an exemplary telecommunication network 100 having different layers representing different technologies is shown. The different layers, which are shown for illustrative purposes only and are not to be construed as limiting the invention, may include a physical layer 12, an optical layer 14, a SONET/SDH layer 16, and an IP layer 18. For the purpose of this disclosure, it may be assumed that the protocols and/or network devices associated with each layer are each managed by one or more corresponding third-party proprietary system 11, 13, 15, and 17, respectively. In the exemplary figure, some portion of the SONET/SDH layer 16 may be managed by a second, legacy system 19. In short, for the example, to use the route, the CSP would have to acquire or purchase routing functionality from up to five third-party providers or would have to tailor its own routing solution.

For example, typically, 2M routes are searched primarily on a SONET Transport network and route search engines return pre-provisioned, VT2 structured STS-1 (51M) circuits. However, it may be desirable to find routes that do not necessarily belong to the same hierarchical level throughout the entire span of the search. For example, although discrete sections of the route on a specific layer may be exhausted, return sections on or belonging to a lower layer(s) that may provide a higher capacity bandwidth may be available for use. In the latter instance, to avoid or prevent exhaustion at one level, it may be possible to add hardware, e.g., by plugging in a new card to one network device, that may allow for that route. The benefits and costs of using a lower hierarchical level include, respectively, a higher capacity bandwidth connection but with an increased metadata requirement. Hence, a lower hierarchical level may be less economical than a route using an available connection on the same hierarchical level. However, in sections of a route, e.g., a bottleneck, where capacity at the same bandwidth level is exhausted and would otherwise yield no possible route, being able to identify an alternate, multi-level route using additional hardware and/or underlying circuitry may provide an option whose benefits can outweigh its costs.

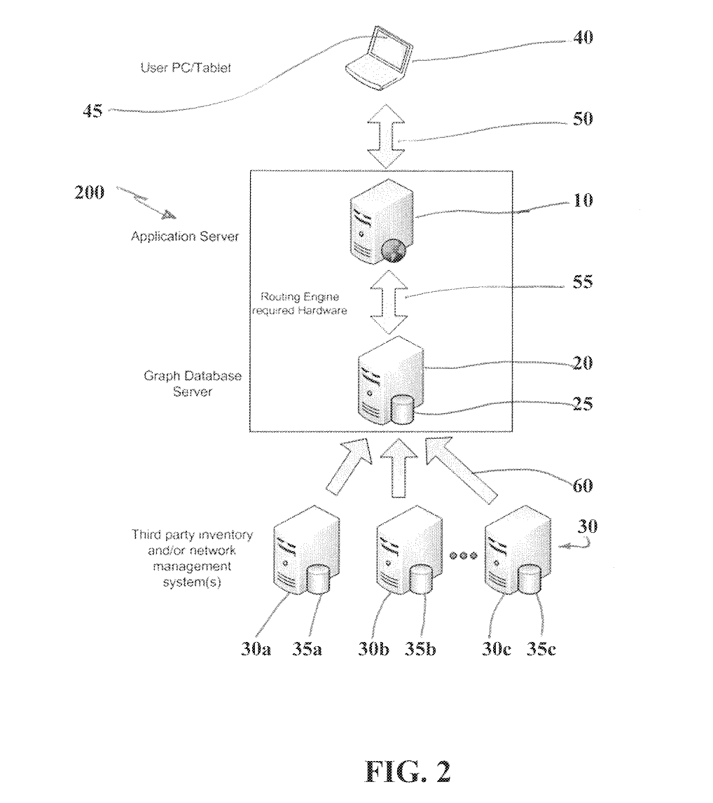

An exemplary architecture of a system 200 for defining a route between network elements or sites that is agnostic to the telecommunication network technology and the telecommunication network domain is shown in FIG. 2. The system includes 200 an application server 10 and a graph database server 20 that are in electronic communication 55 with each other via wireless or hard-wired communication. In some applications, the system 200 is in electronic communication 50, e.g., wirelessly or hard wired, with a first processing device 40, and is in electronic communication 60, e.g., wirelessly or hard wired, with a plurality of third-party systems offering, for example, inventory management services and network management services via at least one second processing device 30a, 30b, 30c. Although FIG. 2 shows two communication networks 50, 60, those of ordinary skill in the art can appreciate that the two communication networks 50, 60 may be the same network or may each comprise a collection of networks, and is not to be construed as limiting the invention in any way. Moreover, both architectural components of the instant routing solution may belong to the same server hardware. Those of ordinary skill in the art can appreciate that either processing device 30, 40 can be embodied as a single device or as a combination of devices.

Components of the system 200 core may be coupled by an interconnection element such as a bus 55. The bus 55 enables communications, e.g., the transfer of data and instructions, to be exchanged, e.g., wirelessly or by hardwire, internally between components and externally between system components. Thus, the bus 55 may include one or more physical busses, e.g., between components that are integrated within the system 200 core, as well as a communication coupling between system elements, e.g., specialized or standard computing bus technologies such as IDE, SCSI, PCI, and InfiniBand. In some variations, components of the system 200 core may be disposed in the same physical server and, thus, physical connectivity between the components may not be required.

The external (to the system core) communication networks 50, 60 may include any communication network through which system or network components may exchange data, e.g., the World, Wide Web, the Internet, an intranet, a wide area network (WAN), a local area network (LAN), and so forth. To exchange data via the communication networks 50, 60, the application server 10, the graph database server 20, the processing devices 30, 40 and the networks 50, 60 themselves may use various methods, protocols, and standards, including, inter alia, token ring, Ethernet, TCP/IP, UDP, HTTP, FTP, and SNMP. The servers 10, 20 and processing devices 30, 40 may include a commercially-available processor such as an Intel Core, Motorola PowerPC, MIPS, UltraSPARC, or Hewlett-Packard PA-RISC processor, but also may be any type of processor or controller as many other processors, microprocessors, and controllers are available. There are many examples of processors currently in use including network appliances, personal computers, workstations, mainframes, networked clients, servers, media servers, application servers, database servers, and web servers. Other examples of processors may include mobile computing devices, such as cellphones, smart phones, Google glasses, tablet computers, laptop computers, personal digital assistants, and network equipment, such as load balancers, routers, and switches.

The application 10 and graph database servers 20 and the processing devices 30, 40 may include an operating system that manages at least a portion of the hardware elements included therein. Usually, a processing device or controller executes an operating system which may be, for example, a Windows-based operating system (e.g., Windows 7, Windows 2000 (Windows ME), Windows XP operating systems, and the like, available from the Microsoft Corporation), a MAC OS System X operating system available from Apple Computer, a Linux-based operating system distributions (e.g., the Enterprise Linux operating system, available from Red Hat Inc.) or a UNIX operating system available from various sources. Many other operating systems may be used, and embodiments are not limited to any particular implementation. Operating systems conventionally may be stored in memory.

The processor or processing device and the operating system together define a processing platform for which application programs in high-level programming languages may be written. These component applications may be executable, intermediate (for example, C-) or interpreted code which communicate over a communication network (for example, the Internet) using a communication protocol (for example, TCP/IP). Similarly, aspects in accordance with the present invention may be implemented using an object-oriented programming language, such as SmallTalk, Java, C++, Ada, or C# (C-Sharp). Other object-oriented programming languages may also be used. Alternatively, functional, scripting, or logical programming languages may be used. For instance, aspects of the system may be implemented using an existing commercial product, such as, for example, Database Management Systems such as SQL Server available from Microsoft of Seattle, Wash., and Oracle Database from Oracle of Redwood Shores, Calif. or integration software such as Web Sphere middleware from IBM of Armonk, N.Y. However, a computer system running, for example, SQL Server may be able to support both aspects in accordance with the present invention and databases for sundry applications not within the scope of the invention. In one or more of the embodiments of the present invention, the processor or processing device is adapted to execute at least one application, algorithm, driver program, and the like, to receive, store, perform mathematical operations on data, and to provide and transmit the data, in their original form and/or, as the data have been manipulated by mathematical operations, to an external communication device for transmission via the network 50, 60. The applications, algorithms, driver programs, and the like that the processor or processing device may process and may execute can be stored in “memory.”

The processor or processing device may also perform functions outside the scope of the invention. In such instances, aspects of the system may be implemented using an existing commercial product, such as, for example, Database Management Systems such as SQL Server available from Microsoft of Seattle, Wash., and Oracle Database (Spatial) from Oracle of Redwood Shores, Calif. or integration software such as Web Sphere middleware from IBM of Armonk, N.Y. However, a computer system running, for example, SQL Server may be able to support both aspects in accordance with the present invention and databases for sundry applications not within the scope of the invention. “Memory” may be used for storing programs and data during operation of the system 200.

“Memory” can be multiple components or elements of a data storage device or, in the alternate, can be stand-alone devices 25, 35a, 35b, 35c. More particularly, “memory” can include volatile storage, e.g., random access memory (RAM), and/or non-volatile storage, e.g., a read-only memory (ROM). The former may be a relatively high performance, volatile, random access memory such as a dynamic random access memory (DRAM) or static memory (SRAM). Various embodiments in accordance with the present invention may organize “memory” into particularized and, in some cases, unique structures to perform the aspects and functions disclosed herein.

The application server 10 includes a processing device that, for example, supports WebLogic 12 and/or Tomcat 7 and/or their equivalent. The application server 10 is structured and arranged to perform the route search, to apply at least one business cost model to each route, and to return optimal route data and to render optimal route images on the user interface 45 of the first processing device 40. For that purpose, the first processing device 40 may include an Internet browser, e.g., Internet Explorer 9, Google Chrome, Mozilla Firefox with Java JRE 1.7, and the like.

Application of one or more business cost models enables comparing each of the routes that are returned. The most cost effective route, which may be the route having a minimum number of hops between network elements, having a minimum temporal length between network elements, having a maximum amount of free capacity (bandwidth) along the route, and so forth, and any combination thereof, may then be determined.

The graph database server 20 includes a processing device and memory that support, for example, Oracle 11G R2 with Graph and Spatial option or an equivalent. The graph database server 20 creates a “distilled” graph representation of the network and keeps the database in sync to facilitate route searches. To that end, the graph database server 20 may be adapted to store minimum information, e.g., in a graph database 25, about network equipment and about connectivity for each underlying inventory/management system. The graph database server 20 can reside on the same or a different level or physical or logical layers from any of the inventory/management systems 30 in the telecommunication network. The only requirement that may affect the disposition of the graph database server 20 is that the server should always be capable of connecting to any and all third-party systems 30, legacy systems, circuits, and so forth regardless of the network technologies and/or domains involved. Accordingly, the graph database server 20 is adapted to retain, i.e., populate and store, and synchronize (‘sync”) connectivity data with the underlying inventory/management system(s) 30.

Traditional network routing systems that operate across telecommunication networks use the same relational database on which the rest of the inventory operates because of the nature of the relational database and the use of indexes, foreign keys, and complex structures, route searches, e.g., searches using algorithms similar to Dijkstra. Were similar cross-layer searches performed using this approach, the temporal length of the search would increase substantially. Accordingly, the present invention uses a graph database 25 that, compared to relational databases, is often faster (for associative data sets) and maps more directly to the structure of the object-oriented applications. The graph database 25 also scales more naturally to larger volume data sets, as it does not require computationally-expensive “join” operations, and because the graph database 25 resides in memory, the search performance is substantially improved.

The graph database 25 is configured to store and synchronize in real-time all of the connectivity data with underlying inventory/management systems 30. In some applications, the graph database 25 contains one row per connection, regardless of the level of hierarchy that any connection belongs to. This allows the routing engine 200 to treat multi-layer, multi-technology, and/or multi-domain connections independently and in the same way as any other connection of the network layer to which the connection belongs.

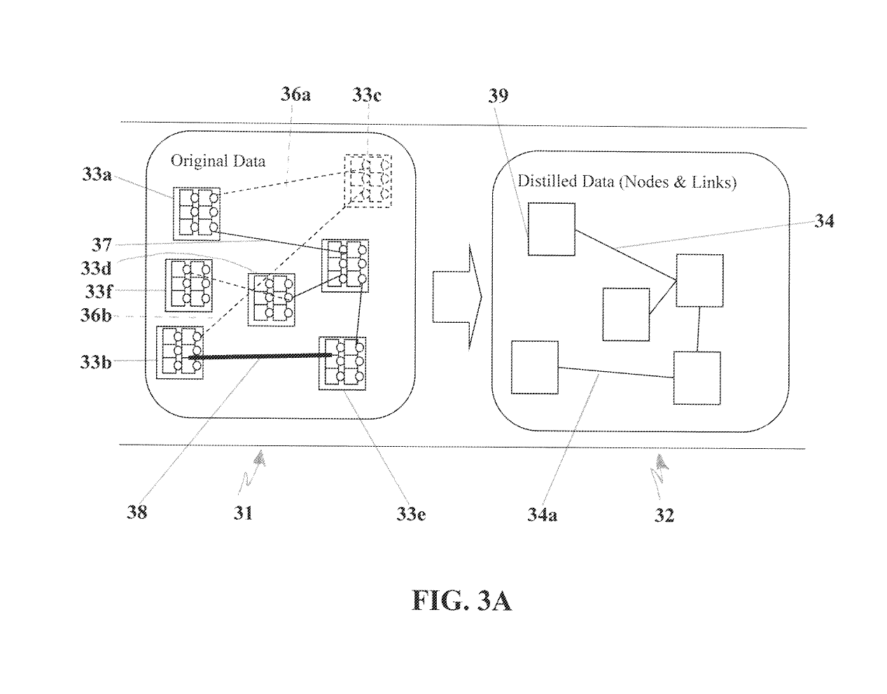

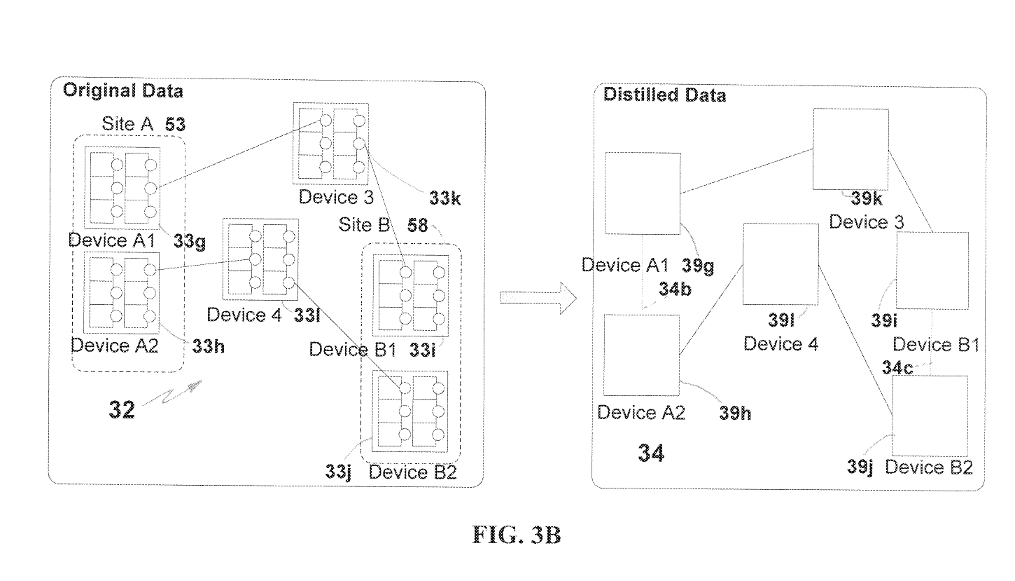

An exemplary illustration of a distilled graph database model is shown in FIG. 3A. The diagram on the left corresponds to original, pre-distillation data 31 while the diagram on the right corresponds to distilled data 32. The pre-distillation data diagram 31 includes equipment and connectivity data for each inventory/management system 30, whereas the distilled data diagram 32 represents the equipment and connectivity data as a series of nodes 39 and links 34. Each node 39 corresponds to a network device and/or equipment and the links 34 represent a connection between two nodes that is available for routing. For example, the original data diagram 31 includes equipment and connectivity data for a variety of network devices and/or equipment 33a-33f as well as the existing connections 36a, 36b, 37, 38 among interconnected equipment/devices. Dotted line connection conventions, e.g., connection 36a between device 33a and device 33c and connection 36b between device 33f and device 33d, and equipment/devices in phantom, e.g., device 33c, represent, respectively, those connections and those equipment/devices in the inventory that are deemed not relevant or useful to routing and, as a result, are not exported to the distilled data diagram 32 (and graph database 25). For example, connections 36a to any management equipment 33c are essentially worthless from a routing standpoint due to the device's 33c unsuitability for routing and, as a result, should not be or are rarely considered as routing candidates. Hence, routes, typically, are not planned through connection 36a or device 33c. As a result, during distillation such equipment/devices 33c and such connections 36a are not imported into the distilled data diagram 32 (and graph database 25).

Some equipment/devices 33f, e.g., an IP router, in the inventory may only be relevant for routing IP circuits. Hence, for an application for routing through transport/transmission circuits 33a, there is no need for IP connections 36b or IP devices 33f, which, accordingly, also may be left out during distillation. As a result, during distillation such equipment 33f and such connections 36b are not exported to the distilled data diagram 32 (and graph database 25).

Connections 37 and 38 correspond to connections between equipment/devices in the inventory that are relevant to routing issues and, as a result, are exported to the distilled data diagram 32 (and graph database 25). Connections 38 depicted in a heavy or bold line may refer to multiple connections between two devices, e.g., 33b and 33e. In some instances, even though there are multiple connections 38, during distillation, just one link 34a may be imported into the distilled data diagram 32 (and graph database 25), especially, for example, if one of the multiple connections 38 is for routing IP circuits between the two devices 33b and 33e.

A second embodiment of a distilled data diagram is shown in FIG. 3B, which shows a case in which neither device in a first pair of devices 33g and 33h nor a second pair of devices 33i and 33j is connected the other device in the original data diagram 31; however, because the devices in the first pair 33g and 33h reside at the same location 53 and the devices in the second pair 33i and 33j reside at the same location 58, in the distilled data graph 32, the first pair of devices 33g and 33h can be represented as node 39g and 39h, respectively, that are connected by link 34b while the second of devices 33i and 33j can be represented as node 39i and 39j, respectively, that are connected by link 34c. By connecting the nodes in the distilled database process and by applying business rules to the connection, at least one route between node 39k and node 39l can be created, where none occurs between device 33k and device 33l in the original data diagram 31.

The distilled data diagram 32 simplifies equipment and connectivity data imported from the original data diagram 31 as a collection of nodes 39 and links 34. Hence, with the distilled data, although, in reality, the network devices and/or equipment may be disposed on the same or on a different level of hierarchy—each subject to its own technology and domain requirements and protocols—and the connections may be on the same level of hierarchy or may span multiple hierarchical levels, the distilled data diagram 32 (and graph database 25) treats them all the same, as if they were on the same hierarchical level.

Synchronizing of the graph database 25 (described in greater detail below) may be performed continuously or periodically. The graph database 25 stores all connections regardless of the network hierarchy level that these connections belong to. As a result, routing may treat them as any other connection and, advantageously, can use them as potential search routes, which a user may filter out on the user interface.

Having described system architecture and the components of that system, the interaction between the components and a method of identifying routes between network elements or sites on a telecommunication network will now be described. As previously described the method is agnostic of the third-party inventory management system(s) and/or network management system(s), which enables efficient routing through multiple domains (time, frequency) and multiple technologies (transport, packet, etc.). Advantageously, the method finds routes automatically using a graph database and costing profiles. Moreover, the method and its supporting systems can be deployed on top of any underlying system containing equipment and connectivity data; hence, it can find routes on the network(s) regardless of the underlying data model that retains the equipment and the connectivity data. Such routes may combine data from the different, which is to say, “different” by technology and/or by domain, underlying systems to identify routes across multiple systems or may operate concurrently on top of different systems acting separately to find routes with equipment and connectivity data from each underlying system. In short, in order to get routes that span across different, underlying inventory systems, the data of those underlying systems must be interpreted and combined together to form one combined graph network database. If the data from the underlying systems were kept separately and loaded separately in the graph distilled database, finding routes spanning across more than one underlying inventory system would not be possible.

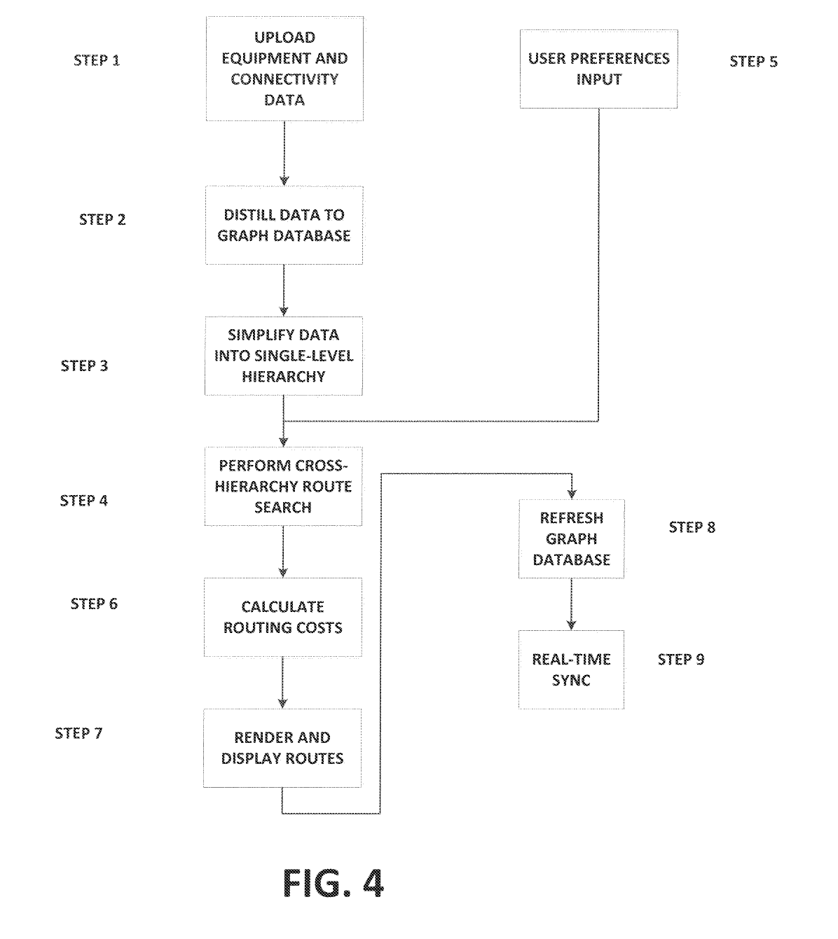

Referring to FIG. 4, an illustrative embodiment of a method of identifying routes between network elements or sites on a telecommunication network is shown. Before routes can be found, existing connectivity information belonging to each of the different network domains, which may be managed by different network systems, e.g., legacy systems, homegrown systems, third-party systems, and the like, should be mapped and uploaded into a graph database (STEP 1). In some embodiments, a graph database is a database that uses and stores graph structures having nodes, edges, and properties to represent network equipment and network connectivity data. For example, network equipment may be modeled as nodes and connectivity information may be modeled as edges. Such an application is suitable for modeling the relationship between connections, e.g., circuits, fibers, and the like, with relevant A-end and Z-end terminating equipment.

In the uploading/data creation process (STEP 1), equipment and connectivity data from each of the systems is extracted from the existing systems and unnecessary information that is not relevant to calculating routes is stripped out in a process referred to as “distillation” (STEP 2) before the data are uploaded into the graph database (STEP 1). Stripping out, i.e., “distilling”, unnecessary information retrieved from each underlying inventory/management system removes equipment structure, e.g., shelves, slots, cards, ports, and so forth (which are normally contained in a relational database), and connection components that are not relevant for routing. The distilling process (STEP 2) comprises essentially of SQL statements being run on the source inventory databases whereby the information required for routing is extracted and loaded into the graph database instance. As mentioned, only the relevant information, i.e., devices and connectivity data, required for routing is loaded. In some variations, only properties required for calculating costs and for scoring routes populate the graph database. For example, a customer may have a business rule whereby different priorities may be given to a particular route depending of an attribute called ‘role’ stored in the inventory against the devices. If this is the case, the attribute ‘role’ present in the inventory against the devices, must be taken to the graph distilled database as it is used to score and calculate the routes. Other customers may not have a priority of routes based on ‘role’ of a device. Therefore, there is no point for this ‘role’ attribute to be imported into the distilled graph database in this scenario.

Advantageously, during distillation (STEP 2), complex circuit hierarchies that are built on each of the inventory/management systems are simplified and, more particularly, the multi-level, multi-technology, and/or multi-domain inventory/management systems are simplified into a single-level hierarchy (STEP 3), which can then be used for expeditious, real-time, cross-hierarchy route searches (STEP 4). For example, in some implementations, each circuit or network device in each hierarchy layer may be represented as a unique row in the graph database. Hence, the graph database eliminates any logic-based hierarchy. Advantageously, whereas existing, conventional routing solutions are manufacturer-specific and only work against proprietary inventor/management systems, the graph database process is agnostic as to the underlying inventory/management systems. This feature enables the system to perform searches between two points across any telecommunication network hierarchy level in seconds. Such logic-based hierarchy, however, may be configured as metadata, as required.

During the real-time, cross-hierarchy route searches, the application server is adapted to execute a program or algorithm, e.g., a Dijkstra algorithm, to search the distilled data in the graph database for the shortest routes (STEP 4) based on parameters input by a user (STEP 5). For example, a user may open a routing user interface e.g., using an Internet browser on the first processing device, and select a network(s) against which the user wants to find route. The user may, then, input a myriad of search parameters and any associated filters, intermediate hops, points to avoid in the network, a relative importance of each of the available cost variables, and so forth. Such input parameters create comprehensive data filters that help focus the search and assign value or cost in accordance with the user's preferences. The user's search parameters may then be transmitted to a routing API residing on the application server. The routing API is adapted to identify and calculate the route(s) from the available network data in the in-memory network, i.e., the graph database, also residing in the application server. Search results returned by the routing API may then be rendered for display (STEP 7) on the user's graphical user interface (GUI). Optionally, the displayed routes may be transmitted to other systems for provisioning and activation.

More particularly, during route search, metadata that has been configured for specific business needs may be applied to each of the identified routes, to provide routing costs (STEP 6). Specific business needs and costs may account for, for example, the number of hops between devices (desire to minimize), the distance between a source point and a destination point of the returned route (desire to minimize), technology costs of routes passing through lower hierarchy circuits, maximum free capacity along the route, a number of fiber patches (i.e., jumpers) that need to be provided for a returned route (desire to minimize), positive attribute costs for routes that go to particular devices in the returned route, negative attribute costs for routes that avoid particular devices in the returned route, diversity costs that, as a protection mechanism, are used in an attempt to find a diverse route from a first returned route to ensure a physically diverse route, the amount of bandwidth free capacity along the route (desire to maximize), timeslot utilization costs associated with trying to fill capacity across a route evenly or, alternatively, to fill capacity in one segment traversed before choosing the route through a circuit having all of its capacity available, and any combination thereof These metadata may be configured to define, for example, which type of connections can be used for routing a specific type of connection selected by the user and those types of connections that are not permitted. Furthermore, these metadata may also be used to configure the cost attributable to each connection type, which becomes a part of the results of the route when calculating “main” and “most diverse” routes. By providing costs (STEP 6) for routing one layer of connection on top of another layer of connection in the routing, configurable metadata, results are optimized. More specifically, searched routes having the least cost will be rendered and displayed first (STEP 7). Cross-domain route solutions will be rendered and displayed (STEP 7) only when they have a cheaper cost, which generally occurs when the capacity of upper layers has been exhausted. The routes may be rendered for display (STEP 7) to the user, e.g., on a GUI associated with the first processing device, in a manner that is well known to the art.

Periodically, e.g., daily, hourly, every 12 hours, and the like, and/or as required by business rules, the entire graph database and in-memory network may be refreshed (STEP 8) with fresh equipment and connectivity data on the underlying inventory/management networks. Additionally, when requested by the user, a real-time sync between underlying inventory/management systems and the distilled graph database, may be performed (STEP 9) to account for delta changes between full refreshes. For example, after the user has invoked, e.g., using the routing user interface, a real-time sync, the distilled graph database is updated as a result of all relevant “delta changes” of the underlying inventory/management systems.

Recognizing that data in the underlying inventory system(s) change all the time, the routing graph distilled database should be in sync (STEP 9) so that correct and most optimal routes can be calculated based on the latest inventory data available. A periodical, e.g. every 24 hour, full refresh (which can take a few minutes to complete, depending on the size of the database), may not occur often enough for the customer requirements. As a request, an interim “delta refresh” (which may take only seconds) may be configured to ensure the data are in real-time sync with the underlying inventory. For example, in some implementations, there can be a two-level refresh approach that may include an overnight full refresh whereby the whole data are re-loaded from the underlying inventory (which takes a few minutes) and user-configurable “delta refreshes” whereby only the delta changes in the underlying inventory from the last time the full refresh occurred are loaded. Although a “delta refresh”—as opposed to the full refresh—takes only a few seconds, it can be considered a real-time refresh that does not affect the user experience or the user trying to find routes. Advantageously, although no routes can be found while the overnight full refresh is taking place, the routing engine works fine during a “delta refresh.”

Changes during a “delta refresh” may include, for the purposes of illustration and not limitation, network planners, designers and implementers making updates to the source inventory systems for network rollouts, network re-arrangements, service activations, and maintenance for service restoration. For example, adding a new device, or a new card to an existing device, to increase capacity in the network. Any “delta changes” may be loaded into the in-memory copy of the graph database in which searches are currently being run. The inventory/management system(s) and the routing components are then aligned and synched in manners well known to those of ordinary skill in the art.

Various embodiments and features of the present invention have been described in detail with particularity. The utilities thereof can be appreciated by those skilled in the art. It should be emphasized that the above-described embodiments of the present invention merely describe certain examples implementing the invention, including the best mode, in order to set forth a clear understanding of the principles of the invention. Numerous changes, variations, and modifications can be made to the embodiments described herein and the underlying concepts, without departing from the spirit and scope of the principles of the invention. All such variations and modifications are intended to be included within the scope of the present invention, as set forth herein. The scope of the present invention is to be defined by the claims, rather than limited by the forgoing description of various preferred and alternative embodiments. Accordingly, what is desired to be secured by Letters Patent is the invention as defined and differentiated in the claims, and all equivalents.

What we claim is:

1. A network routing engine for finding routes between a plurality of network elements, each network element having network equipment and connectivity data, across a communication network, the routing engine comprising:
an application server that is configured and arranged to perform route searches and to identify a route between at least two network elements of the plurality of network elements; and
a routing graph database server having a graph database of network equipment and connectivity data for a plurality of discrete underlying, heterogeneous systems, the routing graph database server adapted to synchronize the connectivity data in the graph database with a corresponding discrete underlying, heterogeneous system, during a search for routes.

2. The network routing engine of claim 1, wherein the communication network is at least one of a multi-technology telecommunication network and a multi-domain telecommunication network.

3. The network routing engine of claim 1, wherein the routing engine is executable on top of a plurality of different underlying systems.

4. The network routing engine of claim 3, wherein the plurality of different underlying systems comprises at least one of inventory systems, element managers, and network managers.

5. The network routing engine of claim 1, wherein a first of the at least two network elements has connectivity data that differs from a second of the at least two network elements.

6. The network routing engine of claim 1, wherein application server is adapted to combine connectivity data for a plurality of different underlying heterogeneous systems to identify a route across multiple systems.

7. A method of finding routes between a plurality of network elements across a communication network, each network element having network equipment and connectivity data, the method comprising:
selecting at least one communication network for finding routes;
reading input search parameters;
providing a server having a routing graph database including connectivity data for each network element;
synchronizing, by the routing graph database, the connectivity data with a corresponding discrete underlying, heterogeneous inventory system;
providing an application server; and
identifying, by the application server, at least one route using the search parameters.

8. The method of claim 7, wherein providing a server having a routing graph database comprises:
enabling the server to connect to each of the plurality of network elements;
enabling the server to extract network equipment and connectivity data from each network element; and
populating the routing graph database with the network equipment and connectivity data.

9. The method of claim 8, wherein populating the routing graph database includes distilling the network equipment and connectivity data to remove information not relevant to calculating a route.

10. The method of claim 9, wherein distilling network equipment and connectivity data includes not importing connections and network equipment that are at least one of not relevant to routing and not useful to routing.

11. The method of claim 10, wherein connections to management equipment are not useful to routing.

12. The method of claim 10, wherein IP connection and IP equipment are not relevant when routing through at least one of transport and transmission circuits.

13. The method of claim 7, wherein identifying at least one route includes applying a business cost to the at least one route.

14. The method of claim 13, wherein the business cost is selected from a group comprising a minimum number of hops, a minimum distance between a source point and a destination point, a minimal cost for routes passing through lower hierarchy circuits, maximum free capacity along the route, a minimum number of fiber patches that need to be provided for a returned route, positive attribute costs for routes that go to particular devices in the returned route, negative attribute costs for routes that avoid particular devices in the returned route, diversity costs to find a diverse route from a first returned route, an amount of bandwidth free capacity along the route (desire to maximize), timeslot utilization costs associated with filling capacity across a route evenly, timeslot utilization costs associated with filling capacity in one segment traversed before choosing a route through a circuit having all of its capacity available, a combination thereof or a weighted combination thereof.

15. The method of claim 7, further comprising combining connectivity data for a plurality of different underlying discrete inventory systems to identify a route across multiple systems.

16. An article of manufacture having computer-readable program portions embedded thereon for finding routes between a plurality of network elements across a communication network, each network element having network equipment and connectivity data, the embedded portions comprising instructions for:
selecting at least one communication network for finding routes;
reading input search parameters;
providing a server having a routing graph database including connectivity data for each network element;
synchronizing, by the routing graph database, the connectivity data with a corresponding discrete underlying, heterogeneous inventory system;
providing an application server; and
identifying, by the application server, at least one route using the search parameters.

17. The article of manufacture of claim 16, wherein providing a server having a routing graph database comprises instructions for:
enabling the server to connect to each of the plurality of network elements;
enabling the server to extract network equipment and connectivity data from each network element; and
populating the routing graph database with the network equipment and connectivity data.

18. The article of manufacture of claim 16, wherein identifying at least one route includes embedded portions comprising instructions for applying a business cost to the at least one route.

19. The article of manufacture of claim 18, wherein the business cost is selected from a group comprising a minimum number of hops, a minimum length, maximum free capacity along the route, a combination thereof or a weighted combination thereof.

20. The article of manufacture of claim 16, wherein the embedded portions further comprise instructions for combining connectivity data for a plurality of different discrete underlying systems to identify a route across multiple systems.

21. The article of manufacture of claim 16, wherein populating the routing graph database includes embedded portions comprising instructions for distilling the network equipment and connectivity data to remove information not relevant to calculating a route.

22. The article of manufacture of claim 21, wherein distilling network equipment and connectivity data includes not importing connections and network equipment that are at least one of not relevant to routing and not useful to routing.

23. The article of manufacture of claim 22, wherein connections to management equipment are not useful to routing.

24. The article of manufacture of claim 22, wherein IP connection and IP equipment are not relevant when routing through at least one of transport and transmission circuits.
